(19) United States
(12) Patent Application Publication
(10) Pub. No.: US 2018/0005722 A1
(43) Pub. Date: Jan. 4, 2018

(54) Corona Shielding Material With An Adjustable Resistance

(71) Applicant: Siemens Aktiengesellschaft, Muenchen (DE)

(72) Inventors: Steffen Lang, Hallerndorf (DE); Bastian Plochmann, Neustadt an der Aisch (DE); Friedhelm Pohlmann, Essen (DE); Christian Staubach, Marl (DE)

(73) Assignee: Siemens Aktiengesellschaft, Muenchen (DE)

(21) Appl. No.: 15/533,233

(22) PCT Filed: Nov. 25, 2015
(86) PCT No.: PCT/EP2015/077609

§ 371 Date: Jun. 5, 2017

(30) Foreign Application Priority Data
Dec. 16, 2014 (DE) 10 2014 226 097.3

(51) Int. Cl. H01B 1/24; C08K 3/34; H02K 3/40

(52) U.S. Cl. CPC H01B 1/24; H02K 3/40; C08K 3/34; C08K 2201/005

(57) ABSTRACT

The present disclosure relates to a corona shielding material. The teachings thereof may be embodied in a material with an adjustable resistance and/or a corona shielding system which comprises an overhang corona shielding system (OCS). In some embodiments, a corona shielding material may include: a matrix; and a filler comprising doped and undoped particles in a given size fraction. A resistance of the corona shielding material is set by a concentration of doped particles in the filler particle size fraction.

### CROSS-REFERENCE TO RELATED APPLICATIONS

This application is a U.S. National Stage application of International Application No. PCT/EP2015/077609 filed Nov. 25, 2015, which designates the United States of America, and claims priority to DE Application No. 10 2014 226 097.3 filed Dec. 16, 2014, the contents of which are hereby incorporated by reference in their entirety.

### TECHNICAL FIELD

The present disclosure relates to a corona shielding material. The teachings thereof may be embodied in a material with an adjustable resistance and/or a corona shielding system which comprises an overhang corona shielding system (OCS).

### BACKGROUND

To prevent partial discharges, the main insulation of generator winding bars and/or similar operating means found in electrical machines with a high rated voltage, e.g., at operating voltages in the kV range (in particular in the range above 3.3 kV), is shielded from cavities and attachments by an inner conducting layer and an outer conducting layer. A corona shielding system of this kind comprises at least an external corona shielding (ECS) and an inner potential grading (IPG). The electrical field strength is reduced in the principal insulation starting from the IPG in a radial direction to the ECS. The ECS ends at the end of the generator winding bar, in the region of the exit point of the winding bars from the stator laminated core, while the main insulation is continued in the direction of the bar end.

This results in a sliding arrangement, e.g., a transformer, a bushing, and/or of a cable, with a low partial discharge inception voltage. FIG. 1 shows a prior art system wherein a cross section through a sliding arrangement at the end of a generator winding bar without OCS with sketched nonlinear potential reduction is schematically illustrated. Said figure shows, at the bottom, the graph of the potential profile, and above this the copper conductor 1 which the main insulation 2 adjoins. The external corona shielding (ECS) 3 is situated between the main insulation 2 and the grounded laminated core 4. The lines 6 show the field line profile at the edge 5 of the ECS 3. The highest field strength occurs at the end/at the edge 5 of the ECS.

Said figure shows that the potential profile at the surface of the main insulation over the length of the copper conductor 1 without overhang corona shielding also has, in addition to the radial component, a strong nonlinear tangential component parallel to the insulating material surface/interface. As shown, the electric field has, in addition to the radial component, a strong nonlinear tangential component parallel to the insulating material surface/interface in said region. The highest field strength of this field component occurs at the end and/or at the edge of the ECS 3 or generally at the end of the outer conducting layer.

To achieve optimized corona shielding, systems implement field control at the edge of the ECS and an increase in dielectric strength in the vicinity of the exposed main insulation. This is usually implemented by producing an overhang corona shielding (OCS). The corona shieldings used in the prior art are generally fabric or conveyor belts composed of glass or polymer material, such as polyester, impregnated with a filler-containing binder. When impregnating individual bars, filler-containing paints are sometimes used. In the case of the ECS, e.g., in the slot region, the electrically conductive filler used is generally carbon black or graphite; in the case of the OCS, e.g., in the end winding region, the filler used is electrically semiconducting silicon carbide.

Resistive potential gradings by semiconducting coatings or belts predominantly based on silicon carbide or other electrically semiconducting fillers have been used for suppressing partial discharges. The tangential potential reduction along the insulating material surface is made more uniform by the overhang corona shielding. Ideally, the potential reduction is even linearized by the OCS. This may be achieved if the absolute value of the voltage drop per unit length is always the same. A resistance per unit length that is voltage-dependent and location-dependent in the axial direction is used for this purpose, as shown in FIG. 2.

FIG. 2 shows the same sliding arrangement as FIG. 1 only with an overhang corona shielding (OCS) 7 at the end of a generator winding bar. Said figure once again shows, at the bottom, the potential profile at the surface of the main insulation over the copper conductor length. Both the potential profile and the field length profile are made more uniform by the OCS. The level of a voltage-dependent resistance per unit length in the OCS is dependent on a large number of factors, including the rated voltage of the generator. To realize the resistance ranges which are set for the individual machine, the silicon carbide is doped by means of chemical processes, sometimes using complicated methods, so that the electrical resistance per unit length of the OCS.

### SUMMARY

Some embodiments of the present teachings may include a corona shielding material comprising a matrix and filler, wherein filler particles are present in a size fraction, that is to say a particle size distribution, wherein the resistance in the corona shielding material can be set by the concentration of doped particles in the filler particle fraction.

In some embodiments, SiC particles are present as filler.

In some embodiments, the SiC particles are present in a particle size of SiC1000, SiC800, SiC600 or SiC400.

In some embodiments, the corona shielding material may comprise a polymeric resin matrix.

In some embodiments, the filler is present in a concentration of above 40% by weight.

In some embodiments, the filler is present in globular form.

In some embodiments, the corona shielding material is part of an overhang corona shielding system.

Some embodiments may include an electrical machine comprising a corona shielding system including a corona shielding material as described above.

Some embodiments may include an electrical machine which is a high-voltage machine.

In some embodiments, there is a corona shielding system for preventing partial discharges, wherein the corona shielding system has an inner potential grading and/or an external corona shielding combined with an overhang corona shielding.

### BRIEF DESCRIPTION OF THE DRAWINGS

FIG. 1 shows a prior art system wherein a cross section through a sliding arrangement at the end of a generator winding bar without OCS with sketched nonlinear potential reduction is schematically illustrated;

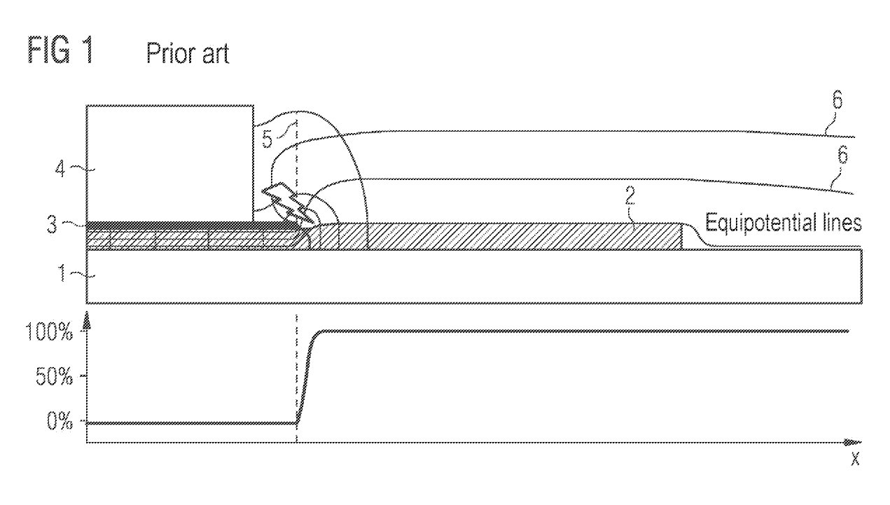

FIG. 2 shows the same sliding arrangement as FIG. 1 only with an overhang corona shielding (OCS) 7 at the end of a generator winding bar; and

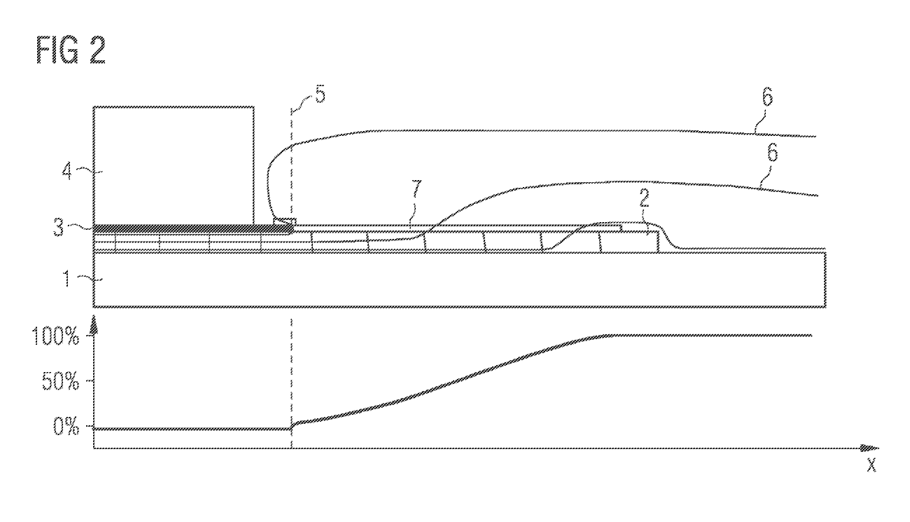

FIG. 3 shows a curve in which the mass fractions of doped SiC in the particle mixture of a corona shielding material are plotted against the square resistance in ohms.

### DETAILED DESCRIPTION

Known system may suffer a first disadvantage in the complicated doping for setting the electrical resistance. A second disadvantage may require different particle sizes for setting a desired resistance in the OCS. A particle mixture containing different particle sizes is not particularly storage stable because it easily separates owing to the different particle sizes. Therefore, mixing is not performed in practice since it would be too complicated and therefore too expensive to store the mixtures in a stable fashion. There are therefore, for example, 4 fillers with different fraction sizes and respective doping. Therefore, resistances per unit length which cover the relevant regions can be produced point by point.

The teachings of the present disclosure may provide a resistance per unit length for a corona shielding system with a filler, in which the resistance can be set in an exact, cost-effective and simple manner. Accordingly, a corona shielding material may comprises a matrix and filler particles in a fraction, that is to say a particle size distribution, wherein the resistance in the corona shielding material can be set by the concentrations of doped particles in the filler particle fraction.

The resistance in the corona shielding material is influenced by the filler. In known systems, the desired resistance has been produced firstly by different particle sizes and secondly by different concentrations of doped particles in the corona shielding material. According to the teachings herein, a resistance in the corona shielding material can be set solely with a particle size of filler particles, solely by varying the concentration of doped particles within the fraction.

The filler is formed with particles with dimensions of, at least on (in particular arithmetic) average, that is to say a particle size distribution, of at most one millimeter e.g., of, at least on (particular arithmetic) average, at most 100 micrometers. The filler may comprise partial discharge-resistant and electrically conductive and/or semiconducting particles, such as silicon carbide. The particles may comprise a partial discharge-resistant core and a partial discharge-resistant coating which is conductive.

In a corona shielding system, the filler may comprise globular and/or planar particles. Globular particles include those particles in which the dimensions in different spatial directions differ by less than a factor of at most 3, e.g., at most 1.5. Planar particles include those particles of which the dimensions in at least one spatial direction differ by a factor of at least 3, e.g., at least 5, from the dimensions in a direction and/or two directions, perpendicular thereto. Owing to the deliberate mixing of doped and undoped filler particles of the same particle size distribution, it is possible to cover a resistance range of more than one decade when the particle mixtures are incorporated into a corresponding matrix.

In some embodiments, the filler is present in the corona shielding material in a quantity of more than 40% by weight, in particular more than 50% by weight, in a quantity of more than 70% by weight and/or in a quantity of more than 80% by weight. The resistance in the corona shielding material drops as the content of doped filler increases. A resistance which is customized for field control of an electrical machine can be set by mixing the doped and undoped filler.

The filler fractions used are, for example, the commercially available particle sizes of, for example, SiC400, SiC600, SiC800 and SiC1000. Here, the number following the material designation “SiC” for silicon carbide represents the number of particles per unit area. Therefore, SiC400 describes larger particles than SiC1000.

As the size of the particle fraction increases, larger particles on average, a lower resistance is generated in the corona shielding material, and vice versa. This is explained by the number of contact resistances between two particles, wherein this number increases with smaller particles, as does the resulting resistance. To cover the required resistance range of a corona shielding system such as an overhang corona shielding system, particle sizes such as SiC400, SiC600, SiC800 and SiC1000 may be used. In case of SiC1000, the dimensions of the particles are approximately 40 μm on average, with a minimum of approximately 4 μm and a maximum of approximately 50 μm.

For the initial range, SiC is also sometimes mixed with carbon black, in order to lower the resistance. The particles may be doped with aluminum or boron.

In some embodiments, the corona shielding system further comprises a support such as a belt and/or a fabric. In some embodiments, at least a portion of the corona shielding material forms a belt and/or a coating in the case of the corona shielding system.

In some embodiments, the corona shielding material comprises a matrix, for example a polymeric matrix, e.g., a plastic matrix and/or a resin. The polymeric matrix may comprise a thermoplastic and/or a thermoset and/or an elastomer.

In some embodiments, the corona shielding material has an electrical resistance which becomes lower the greater an electrical operating field of the electrical machine in which the corona shielding material, during operation, is located.

In some embodiments, OCS corona shielding materials which cover 2 decades of resistances can be produced solely by two filler fractions.

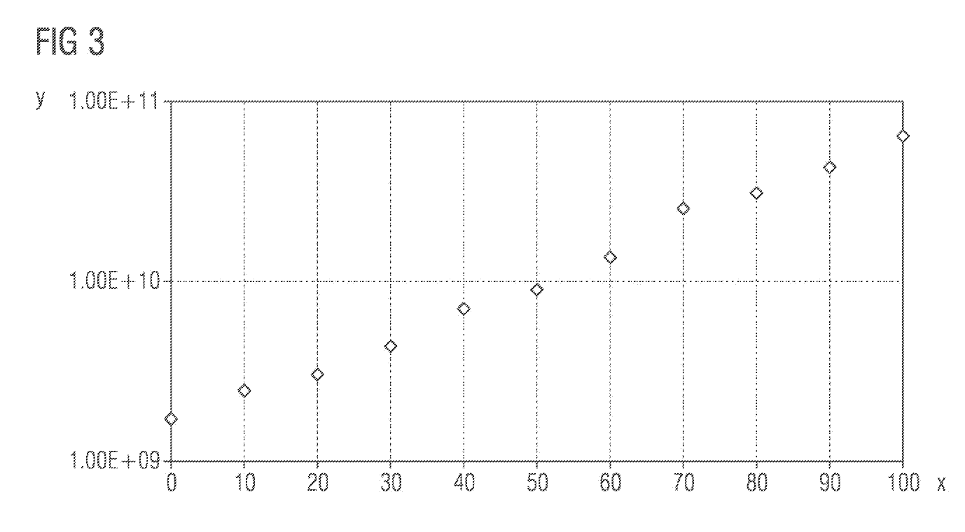

FIG. 3 shows a curve in which the mass fractions of doped SiC in the particle mixture of a corona shielding material are plotted against the square resistance in ohms. Said curve exhibits a profile which is linear within the measurement accuracies with an increasing proportion of undoped SiC in the particle mixture the resistance in ohms also arises. It is shown here that the electrical resistance can be set in nuances according to the teachings herein, e.g., to set virtually any desired resistance value in the corona shielding material by varying the quantity of doped particles.

In some embodiments, the set mixtures are storage-stable to a virtually unlimited extent because the fundamental uniformity of the particle size prevents separation into relatively large and relatively small particle fractions over relatively long-term storage. Therefore, a reproducible electrical resistance per unit length is produced.

In some embodiments, there is a corona shielding material for a corona shielding system which comprises an overhang corona shielding system (OCS). Here, a corona shielding material is introduced in which the filler is present in a single particle size fraction, embedded in a matrix, and a desired electrical resistance can be set.

What is claimed is:

1. A corona shielding material comprising:
a matrix; and
a filler comprising doped and undoped particles in a given size fraction;
wherein a resistance of the corona shielding material is set by a concentration of doped particles in the filler particle size fraction.

2. The corona shielding material as claimed in claim 1, the filler includes SiC particles.

3. The corona shielding material as claimed in claim 1, wherein the filler comprises SiC particles in a particle size of SiC1000, SiC800, SiC600, or SiC400.

4. The corona shielding material as claimed in claim 1, wherein the matrix includes a polymeric resin.

5. The corona shielding material as claimed in claim 1, wherein the filler comprises above 40% by weight of a total weight of the corona shielding material.

6. The corona shielding material as claimed in claim 1, wherein the filler includes particles with a globular form.

7. The corona shielding material as claimed in claim 1, wherein the corona shielding material comprises part of an overhang corona shielding system.

8. An electrical machine comprising:
a corona shielding system including:
a matrix; and
a filler comprising doped and undoped particles in a given size fraction;
wherein a resistance of the corona shielding material is set by a concentration of doped particles in the filler particle size fraction.

9. An electrical machine as claimed in claim 8, wherein the electrical machine comprises a high-voltage machine.

10. The electrical machine as claimed in claim 8, wherein the corona shielding system includes:
an inner potential grading or an external corona shielding; and
an overhang corona shielding.
